(19) United States
(12) Patent Application Publication
(10) Pub. No.: US 2020/0329422 A1
(43) Pub. Date: Oct. 15, 2020

(54) NON-PUBLIC NETWORKS SUPPORT BY NG RADIO ACCESS NETWORK (NG-RAN)

(71) Applicant: Intel Corporation, Santa Clara, CA (US)

(72) Inventors: Alexander Sirotkin, Hod Hasharon (IL); Seau S. Lim, Swindon (GB)

(21) Appl. No.: 16/911,904

(22) Filed: Jun. 25, 2020

Related U.S. Application Data
(60) Provisional application No. 62/882,815, filed on Aug. 5, 2019.

(51) Int. Cl. H04W 48/16; H04W 48/10; H04W 76/11; H04W 8/12; H04W 76/25; H04W 8/26

(52) U.S. Cl. CPC H04W 48/16; H04W 48/10; H04W 8/26; H04W 8/12; H04W 76/25; H04W 76/11

(57) ABSTRACT

Embodiments herein provide techniques for a next generation radio access node (NG-RAN, such as a next generation base station (gNB)) and an access and mobility management function (AMF) to share information associated with a non-public network. In an embodiment, the NG-RAN node transmits a NG SETUP REQUEST message to the AMF that includes at least one closed access group (CAG) or network identifier (NID) associated with the NPN. The NPN may be a stand-alone NPN (SNPN) or a public network integrated NPN (PNI-NPN). Other embodiments may be described and claimed.

### CROSS REFERENCE TO RELATED APPLICATION

The present application claims priority to U.S. Provisional Patent Application No. 62/882,815, titled “NON-PUBLIC NETWORKS SUPPORT BY NG-RAN,” which was filed Aug. 5, 2019, the disclosure of which is hereby incorporated by reference.

### FIELD

Embodiments of the present invention relate generally to the technical field of wireless communications.

### BACKGROUND

A 5G non-public network (NPN), also sometimes called a private network, provides 5G network services to a clearly defined user organization or group of organizations, in contrast to a network that offers mobile network services to the general public. An NPN may be deployed as a stand-alone NPN (SNPN) or a public network integrated NPN (PNI-NPN). An SNPN may be, for example, operated by an NPN operator and may not rely on network functions provided by a public land mobile network (PLMN). A PNI-NPN may be, for example, a non-public network deployed with the support of a PLMN.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1A illustrates a service-based representation of a policy and charging control framework for a 5G system (5GS).

FIG. 1B illustrates a reference point representation of a policy and charging control framework for the 5GS.

FIG. 2 illustrates an operation flow/algorithmic structure in accordance with some embodiments.

FIG. 3 illustrates another operation flow/algorithmic structure in accordance with some embodiments.

FIG. 4 illustrates an example architecture of a system of a network, in accordance with various embodiments.

FIG. 5 illustrates an example architecture of a system including a first core network (CN), in accordance with various embodiments.

FIG. 6 illustrates an example architecture of a system including a second CN, in accordance with various embodiments.

FIG. 7 illustrates an example of infrastructure equipment in accordance with various embodiments.

FIG. 8 is a block diagram illustrating components, according to some example embodiments, able to read instructions from a machine-readable or computer-readable medium (for example, a non-transitory machine-readable storage medium) and perform any one or more of the methodologies discussed herein.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include any combination of integrated circuits (for example, a field-programmable gate array (FPGA), an application specific integrated circuit (ASIC), etc.), discrete circuits, combinational logic circuits, system on a chip (SOC), system in a package (SiP), that provides the described functionality. In some embodiments, the circuitry may execute one or more software or firmware modules to provide the described functions. In some embodiments, circuitry may include logic, at least partially operable in hardware.

Various embodiments herein provide stage-3 signaling for next generation (NG)-radio access network (RAN) interfaces (e.g., NG, Xn, and/or F1 interfaces) to support SNPN and/or PNI-NPN. For example, aspects of the disclosed embodiments include:
NG-RAN is preconfigured (e.g. via operations, administration, and maintenance (OAM)) with lists of Closed Access Group (CAG) and Network identifier (NID) it supports, for PNI-NPN and SNPN, respectively.
NG-RAN communicates this information to access and mobility management function (AMF) in NG SETUP REQUEST and RAN CONFIGURATION UPDATE NG-AP messages. The AMF may use it, for example, for handover (via 5GC) decisions.
NG-RAN communicates to an AMF a CAG ID and/or NID selected by a UE in INITIAL UE MESSAGE message. The AMF may use it, for example, to accept the request.
An AMF may include a list of allowed CAGs for a UE in Mobility Restriction List IE. The NG-RAN node uses this information for e.g. Xn handover decisions.

Furthermore, in case of centralized unit (CU)/distributed unit (DU) split deployments:
gNB-DU is preconfigured (e.g., via OAM) with lists of CAG(s) and/or NID(s) it supports, for PNI-NPN and SNPN, respectively.
gNB-DU communicates this information to gNB-CU using F1 SETUP REQUEST and GNB-DU CONFIGURATION UPDATE messages.
the gNB-CU may activate/deactivate certain CAGs/NIDs, for which Cells to be Activated List in F1 Setup Response, GNB-DU Configuration Acknowledge and GNB-CU Configuration Update can be extended with this information.

### Definitions

5GS, and therefore NG-RAN, shall support two types of Non-Public Networks: standalone and public network integrated. Stage-2 description of these features provides the following definitions:
a Stand-alone Non-Public Network (SNPN), for example, operated by an NPN operator and not relying on network functions provided by a PLMN, or
a Public network integrated NPN (PNI-NPN), for example, a non-public network deployed with the support of a PLMN.

SNPN is a standalone dedicated network. PNI-NPN, on the other hand, is made available via PLMNs using dedicated DNNs or slicing. A Closed Access Group (CAG) is used to prevent UEs, which are not allowed to access the PNI-NPN, from automatically selecting and accessing the associated cell. CAG identifies a group of subscribers who are permitted to access one or more CAG cells associated to the CAG.

Different identifiers are used for SNPN and PNI-NPN.

A SNPN is identified by the combination of a PLMN ID and Network identifier (NID). A cell may support up to 12 NIDs. There can also be an optional human-readable network name per NID.

For NPI-NPN, a CAG is identified by a CAG Identifier which is unique within the scope of a PLMN ID. A cell may have a list of up to 12 CAG ids. A CAG cell may optionally have a human-readable network name per CAG Identifier.

The present disclosure describes NG-RAN aspects of NPN and provides a detailed analysis regarding how these features affect NG-RAN network interfaces, specifically, NG, Xn, F1 and/or E1.

Cardinality

The current version of stage-2 description states, “It is assumed that an NG-RAN node supports broadcasting a total of twelve NIDs” and “It is assumed that an NG-RAN node supports broadcasting a total of twelve CAG Identifiers.” However, limiting the number of NIDs and CAGs on per NG-RAN node basis to such a small value may not be justified. In LTE, an eNB could support up to 256 CSG ids. If anything, this number should be larger in NG-RAN, especially in deployments with CU/DU split. Therefore, the stage-2 limitation of 12 NIDs/CAGs may be interpreted as per cell and to support at least 256 identifiers per network node, gNB-CU in this case. A gNB-DU may support a lower number of CAGs/NIDs.

As for the maximum number of CAGs to be supported by UE (in mobility restriction list), this decision will depend on the decision regarding the air interface.

NG-RAN Configuration

It is reasonable to assume that NG-RAN is pre-configured (e.g., via OAM) with a list of CAGs and NIDs it supports. In the split NG-RAN deployment, we will assume that it is the gNB-CU which is preconfigured with this information.

It may be beneficial for the 5GC to know this information, which can be used, for example, for handovers via 5GC. It is therefore proposed to support NG-AP signaling to communicate NIDs/CAGs supported to an AMF in NG SETUP REQUEST and RAN CONFIGURATION UPDATE NG-AP messages. In below examples, the proposed configurations and/or information inclusions are underlined, according to various embodiments.

### 1.1.1.1 NG Setup Request

This message is sent by the NG-RAN node to transfer application layer information for an NG-C interface instance.

Direction: NG-RAN node→AMF

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| Global RAN Node ID | M | | 9.3.1.5 | | YES | reject |
| RAN Node Name | O | | PrintableString | | YES | ignore |
| | | | (SIZE(1 . . . 150, . . .)) | | | |
| Supported TA List | | 1 | | Supported TAs in | YES | reject |
| | | | | the NG-RAN | | |
| | | | | node. | | |
| >Supported TA Item | | 1 . . . <maxnoofTACs> | | | — | |
| >>TAC | M | | 9.3.3.10 | Broadcast TAC | — | |
| >>Broadcast PLMN | | 1 | | | — | |
| List | | | | | | |
| >>>Broadcast | | 1 . . . <maxnoofBPLMNs> | | | — | |
| PLMN Item | | | | | | |
| >>>>PLMN | M | | 9.3.3.5 | Broadcast PLMN | — | |
| Identity | | | | | | |
| >>>>TAI Slice | M | | Slice Support | Supported S- | — | |
| Support List | | | List | NSSAIs per TA. | | |
| | | | 9.3.1.17 | | | |
| >>>> CAG List | O | | 9.3.1.x1 | Supported CAGs | | |
| >>>> NID List | O | | 9.3.1.x2 | Supported NIDs | | |
| Default Paging DRX | M | | Paging DRX | | YES | ignore |
| | | | 9.3.1.90 | | | |
| UE Retention | O | | 9.3.1.117 | | YES | ignore |
| Information | | | | | | |

| Range bound | Explanation |
|---|---|
| maxnoofTACs | Maximum no. of TACs. Value is 256. |
| maxnoofBPLMNs | Maximum no. of Broadcast PLMNs. Value is 12. |

### 1.1.1.2 9.2.6.4 RAN Configuration Update

This message is sent by the NG-RAN node to transfer updated application layer information for an NG-C interface instance.

Direction: NG-RAN node→AMF

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| RAN Node Name | O | | PrintableString | | YES | ignore |
| | | | (SIZE(1 . . . 150, . . .)) | | | |
| Supported TA List | | 0 . . . 1 | | Supported TAs in | YES | reject |
| | | | | the NG-RAN | | |
| | | | | node. | | |
| >Supported TA Item | | 1 . . . <maxnoofTACs> | | | — | |
| >>TAC | M | | 9.3.3.10 | Broadcast TAC | — | |
| >>Broadcast PLMN | | 1 | | | — | |
| List | | | | | | |
| >>>Broadcast | | 1 . . . <maxnoofBPLMNs> | | | — | |
| PLMN Item | | | | | | |
| >>>>PLMN | M | | 9.3.3.5 | Broadcast PLMN | — | |
| Identity | | | | | | |
| >>>>TAI Slice | M | | Slice Support | Supported S- | — | |
| Support List | | | List | NSSAIs per TA. | | |
| | | | 9.3.1.17 | | | |
| >>>> CAG List | O | | 9.3.1.x1 | Supported CAGs | | |
| >>>> NID List | O | | 9.3.1.x2 | Supported NIDs | | |
| Default Paging DRX | O | | Paging DRX | | YES | ignore |
| | | | 9.3.1.90 | | | |
| Global RAN Node ID | O | | 9.3.1.5 | | YES | ignore |

| Range bound | Explanation |
|---|---|
| maxnoofTACs | Maximum no. of TACs. Value is 256. |
| maxnoofBPLMNs | Maximum no. of Broadcast PLMNs. Value is 12. |

9.3.1.x1 CAG List

This IE indicates the list of CAGs.

| | | | | |
|---|---|---|---|---|
| | | | IE type and | Semantics |
| IE/Group Name | Presence | Range | reference | description |

| | | | |
|---|---|---|---|
| CAG Item | | 1 . . . <maxnoofCAGs> | |
| >CAG ID | M | | 9.3.1.x3 |
| >CAG Name | O | | PrintableString |
| | | | (SIZE(1 . . . 100, . . .)) |

| Range bound | Explanation |
|---|---|
| maxnoofCAGs | Maximum no. of CAGs. Value is 256. |

9.3.1.x3 CAG ID

This IE uniquely identifies the CAG within a PLMN.

| | | | | |
|---|---|---|---|---|
| | | | IE type and | Semantics |
| IE/Group Name | Presence | Range | reference | description |

| | | |
|---|---|---|
| CAG ID | M | INTEGER |

9.3.1.x4 NID List

This IE indicates the list of CAGs.

| | | | | |
|---|---|---|---|---|
| | | | IE type and | Semantics |
| IE/Group Name | Presence | Range | reference | description |

| | | | |
|---|---|---|---|
| CAG Item | | 1 . . . <maxnoofNIDs> | |
| >NID | M | | 9.3.1.x3 |
| >NID Name | O | | PrintableString |
| | | | (SIZE(1. . . 100, . . .) |

| Ranee bound | Explanation |
|---|---|
| maxnoofNIDs | Maximum no. of NIDs. Value is 256. |

9.3.1.x5 NID

This IE identifies the NID.

| | | | | |
|---|---|---|---|---|
| | | | IE type and | Semantics |
| IE/Group Name | Presence | Range | reference | description |

| | | |
|---|---|---|
| NID | M | INTEGER |

Regarding the split NG-RAN deployment, in some embodiments, not all distributed units (DUs) under the same centralized unit (CU) may necessarily support all CAGs and NIDs, and therefore exchange of this information over the F1 interface is needed. It is further assumed that which CAGs and NIDs are supported is pre-configured in the DU by its OAM, however the CU still maintains the control over which CAGs/NIDs are currently active.

Therefore, such exchange is modeled based on the current scheme of exchanging cell information: a DU sends to the CU information about which CAGs/NIDs it supports, and the CU may decide to activate/deactivate some or all of these. The CAG/NID information can be signaled as part of the Served Cell Information IE or separately. In order to simplify the signaling and to allow the CU to get the full picture, the Served Cell Information IE may be extended to carry CAG and NID lists. Actual CAG/NID IE definition for 38.473 can be identical to that of the IE definition in TS 38.413.

The inclusion of CAG/NID information in the Served Cell Information IE allows a DU to signal it in F1 Setup Request and GNB-DU Configuration Update. Additionally, a CU may be allowed to activate/deactivate certain CAGs/NIDs, for which Cells to be Activated List in F1 Setup Response, GNB-DU Configuration Acknowledge and GNB-CU Configuration Update can be extended with this information.

### 1.1.1.3 9.3.1.10 Served Cell Information

This IE contains cell configuration information of a cell in the gNB-DU.

| | | | IE type and | Semantics | Criti- | Assigned |
|---|---|---|---|---|---|---|
| IE/Group Name | Presence | Range | reference | description | cality | Criticality |
| NR CGI | M | | 9.3.1.12 | | — | |
| NR PCI | M | | INTEGER | Physical Cell ID | — | |
| | | | (0 . . . 1007) | | | |
| 5GS TAC | O | | 9.3.1.29 | 5GS Tracking Area | — | |
| | | | | Code | | |
| Configured EPS TAC | O | | 9.3.1.29a | | — | |
| Served PLMNs | | 1 . . . <maxnoofBPLMNs> | | Broadcast PLMNs | — | |
| >PLMN Identity | M | | 9.3.1.14 | | — | |
| >TAI Slice Support | O | | Slice Support | Supported S- | YES | ignore |
| List | | | List | NSSAIs per TA. | | |
| | | | 9.3.1.37 | | | |
| > CAG List | O | | 9.3.1.x1 | Supported | | |
| | | | | CAGs | | |
| > NID List | O | | 9.3.1.x2 | Supported | | |
| | | | | NIDs | | |
| CHOICE NR-Mode-Info | M | | | | — | |
| >FDD | | | | | — | |
| >>FDD Info | | 1 | | | — | |
| >>>UL | M | | NR Frequency | | — | |
| FreqInfo | | | Info | | | |
| | | | 9.3.1.17 | | | |
| >>>DL | M | | NR Frequency | | — | |
| FreqInfo | | | Info | | | |
| | | | 9.3.1.17 | | | |
| >>>UL | M | | Transmission | | — | |
| Transmission | | | Bandwidth | | | |
| Bandwidth | | | 9.3.1.15 | | | |
| >>>DL | M | | Transmission | | — | |
| Transmission | | | Bandwidth | | | |
| Bandwidth | | | 9.3.1.15 | | | |
| >TDD | | | | | — | |
| >>TDD Info | | 1 | | | — | |
| >>>NR | M | | NR Frequency | | — | |
| FreqInfo | | | Info | | | |
| | | | 9.3.1.17 | | | |
| >>> | M | | Transmission | | — | |
| Transmission | | | Bandwidth | | | |
| Bandwidth | | | 9.3.1.15 | | | |
| Measurement Timing | M | | OCTET | Contains the | — | |
| Configuration | | | STRING | MeasurementTimingConfiguration | | |
| | | | | inter-node message | | |
| | | | | defined in TS | | |
| | | | | 38.331 [8]. | | |
| RANAC | O | | RAN Area | | YES | ignore |
| | | | Code | | | |
| | | | 9.3.1.57 | | | |
| Extended Served | | 0 . . . 1 | | This is included if | YES | ignore |
| PLMNs List | | | | more than 6 Served | | |
| | | | | PLMNs is to be | | |
| | | | | signalled. | | |
| >Extended Served | | 1 . . . <maxnoofExtendedBPLMNs> | | | — | |
| PLMNs Item | | | | | | |
| >>PLMN Identity | M | | 9.3.1.14 | | — | |
| >>TAI Slice | O | | Slice Support | Supported S- | — | |
| Support List | | | List | NSSAIs per TA. | | |
| | | | 9.3.1.37 | | | |
| >> CAG List | O | | 9.3.1.x1 | Supported CAGs | | |
| >> NID List | O | | 9.3.1.x2 | Supported NIDs | | |
| Cell Direction | O | | 9.3.1.78 | | YES | ignore |
| Cell Type | O | | 9.3.1.87 | | YES | ignore |
| Broadcast PLMN | | 0 . . . <maxnoofBPLMNsNR−1> | | This IE | YES | ignore |
| Identity Info List | | | | corresponds to the | | |
| | | | | PLMN- | | |
| | | | | IdentityInfoList IE | | |
| | | | | in SIB1 as specified | | |
| | | | | in TS 38.331 [8]. | | |
| | | | | The PLMN | | |
| | | | | Identities and | | |
| | | | | associated | | |
| | | | | information | | |
| | | | | contained in this IE | | |
| | | | | shall be provided in | | |
| | | | | the same order as | | |
| | | | | broadcast in SIB1. | | |
| >PLMN Identity List | M | | Available | | — | |
| | | | PLMN List | | | |
| | | | 9.3.1.65 | | | |
| >Extended PLMN | O | | Extended | | — | |
| Identity List | | | Available | | | |
| | | | PLMN List | | | |
| | | | 9.3.1.76 | | | |
| >5GS-TAC | O | | OCTET | | — | |
| | | | STRING (3) | | | |
| >NR Cell Identity | M | | BIT STRING | | — | |
| | | | (36) | | | |
| >RANAC | O | | RAN Area | | — | |
| | | | Code | | | |
| | | | 9.3.1.57 | | | |

| Range bound | Explanation |
|---|---|
| maxnoofBPLMNs | Maximum no. of Broadcast PLMN Ids. |
| | Value is 6. |
| maxnoofExtendedBPLMNs | Maximum no. of Extended Broadcast |
| | PLMN Ids. Value is 6. |
| maxnoofBPLMNsNR−1 | Maximum no. of PLMN Ids. broadcast |
| | in an NR cell minus 1. Value is 11. |

Network Access

When a UE first accesses the network, the stage-2 mandates that the selected CAG or NID are sent to the AMF according to TS 23.502. While there are differences in how CAG or NID are used, the signaling may be configured in similar approaches. For example, the Ng-AP INITIAL UE MESSAGE may be used to convey this information.

### 1.1.1.4 9.2.5.1 Initial UE Message

This message is sent by the NG-RAN node to transfer the initial layer 3 message to the AMF over the NG interface.

Direction: NG-RAN node→AMF

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| RAN UE NGAP ID | M | | 9.3.3.2 | | YES | reject |
| NAS-PDU | M | | 9.3.3.4 | | YES | reject |
| User Location | M | | 9.3.1.16 | | YES | reject |
| Information | | | | | | |
| RRC Establishment | M | | 9.3.1.111 | | YES | ignore |
| Cause | | | | | | |
| 5G-S-TMSI | O | | 9.3.3.20 | | YES | reject |
| AMF Set ID | O | | 9.3.3.12 | | YES | ignore |
| UE Context Request | O | | ENUMERATED | Indicates that a UE | YES | ignore |
| | | | (requested, . . .) | context including | | |
| | | | | security | | |
| | | | | information needs | | |
| | | | | to be setup at the | | |
| | | | | NG-RAN. | | |
| Allowed NSSAI | O | | 9.3.1.31 | | YES | reject |
| CAG ID | O | | INTEGER | | | |
| NIP | O | | INTEGER | | | |

Mobility

For SNPN, the mobility is handled as it is in a normal network. This is because SNPN is isolated from other networks. For PNI-NPN, there are certain mobility restrictions, which can be handled using the Mobility Restriction List IE, as per TS 23.502:

“Mobility Restrictions restrict mobility handling or service access of a UE. It consists of RAT restriction, Forbidden area, Service area restrictions and Core Network type restriction. It may also contain an Allowed CAG list and, optionally an indication whether the UE is only allowed to access 5GS via CAG cells.”

### 1.1.1.5 9.3.1.85 Mobility Restriction List

This IE defines roaming or access restrictions for subsequent mobility action for which the NR-RAN provides information about the target of the mobility action towards the UE, e.g., handover, or for SCG selection during dual connectivity operation or for assigning proper RNAs. If the NG-RAN receives the Mobility Restriction List IE, it shall overwrite previously received mobility restriction information. NG-RAN behaviour upon receiving this IE is specified in TS 23.501.

| | | | IE type and | Semantics | | Assigned |
|---|---|---|---|---|---|---|
| IE/Group Name | Presence | Range | reference | description | Criticality | Criticality |
| Serving PLMN | M | | PLMN Identity | | — | |
| | | | 9.3.3.5 | | | |
| Equivalent PLMNs | | 0 . . . <maxnoofEPLMNs> | | Allowed PLMNs | — | |
| | | | | in addition to | | |
| | | | | Serving PLMN. | | |
| | | | | This list | | |
| | | | | corresponds to the | | |
| | | | | list of “equivalent | | |
| | | | | PLMNs” as | | |
| | | | | defined in TS | | |
| | | | | 24.501 [26]. | | |
| | | | | This list is part of | | |
| | | | | the roaming | | |
| | | | | restriction | | |
| | | | | information. | | |
| | | | | Roaming | | |
| | | | | restrictions apply | | |
| | | | | to PLMNs other | | |
| | | | | than the Serving | | |
| | | | | PLMN and | | |
| | | | | Equivalent | | |
| | | | | PLMNs. | | |
| >PLMN Identity | M | | 9.3.3.5 | | — | |
| RAT Restrictions | | 0 . . . <maxnofEPLMNsPlusOne> | | This IE contains | — | |
| | | | | RAT restriction | | |
| | | | | related information | | |
| | | | | as specified in TS | | |
| | | | | 23.501 [9]. | | |
| >PLMN Identity | M | | 9.3.3.5 | | — | |
| >RAT Restriction | M | | BIT STRING | Each position in | — | |
| Information | | | {e-UTRA (0), | the bitmap | | |
| | | | nR(1)} | represents a RAT. | | |
| | | | (SIZE(8, . . .)) | If a bit is set to | | |
| | | | | “1”, the respective | | |
| | | | | RAT is restricted | | |
| | | | | for the UE. | | |
| | | | | If a bit is set to | | |
| | | | | “0”, the respective | | |
| | | | | RAT is not | | |
| | | | | restricted for the | | |
| | | | | UE. | | |
| | | | | This version of the | | |
| | | | | specification does | | |
| | | | | not use bits 2-7, | | |
| | | | | the sending node | | |
| | | | | shall set bits 2-7 to | | |
| | | | | “0”, the receiving | | |
| | | | | node shall ignore | | |
| | | | | bits 2-7. | | |
| Forbidden Area | | 0 . . . <maxnoofEPLMNsPlusOne> | | This IE contains | — | |
| Information | | | | Forbidden Area | | |
| | | | | information as | | |
| | | | | specified in TS | | |
| | | | | 23.501 [9]. | | |
| >PLMN Identity | M | | 9.3.3.5 | | — | |
| >Forbidden TACs | | 1 . . . <maxnoofForbTACs> | | | — | |
| >>TAC | M | | 9.3.3.10 | The TAC of the | — | |
| | | | | forbidden TAI. | | |
| Service Area | | 0 . . . <maxnoofEPLMNsPlusOne> | | This IE contains | — | |
| Information | | | | Service Area | | |
| | | | | Restriction | | |
| | | | | information as | | |
| | | | | specified in TS | | |
| | | | | 23.501 [9]. | | |
| >PLMN Identity | M | | 9.3.3.5 | | — | |
| >Allowed TACs | | 0 . . . <maxnoofAllowedAreas> | | | — | |
| >>TAC | M | | 9.3.3.10 | The TAC of the | — | |
| | | | | allowed TAI. | | |
| >Not Allowed TACs | | 0 . . . <maxnoofAllowedAreas> | | | — | |
| >>TAC | M | | 9.3.3.10 | The TAC of the | — | |
| | | | | not-allowed TAI. | | |
| Last E-UTRAN PLMN | O | | PLMN Identity | Indicates the E- | YES | ignore |
| Identity | | | 9.3.3.5 | UTRAN PLMN | | |
| | | | | ID from where the | | |
| | | | | UE formerly | | |
| | | | | handed over to | | |
| | | | | 5GS and which is | | |
| | | | | preferred in case of | | |
| | | | | subsequent | | |
| | | | | mobility to EPS. | | |
| Core Network Type | O | | ENUMERATED | Indicates whether | YES | ignore |
| Restriction for Serving | | | (EPCForbidden, . . .) | the UE is restricted | | |
| PLMN | | | | to connect to EPC | | |
| | | | | for the Serving | | |
| | | | | PLMN as specified | | |
| | | | | in TS 23.501 [9]. | | |
| Core Network Type | | 0 . . . <maxnoofEPLMNs> | | | YES | ignore |
| Restriction for | | | | | | |
| Equivalent PLMNs | | | | | | |
| >PLMN Identity | M | | 9.3.3.5 | Includes any of the | — | |
| | | | | Equivalent PLMNs | | |
| | | | | listed in the | | |
| | | | | Mobility | | |
| | | | | Restriction List IE | | |
| | | | | for which CN | | |
| | | | | Type restriction | | |
| | | | | applies as | | |
| | | | | specified in TS | | |
| | | | | 23.501 [9]. | | |
| >Core Network Type | M | | ENUMERATE | Indicates whether | | |
| Restriction | | | D(EPCForbidden, | the UE is restricted | | |
| | | | 5GCForbidden, . . .) | to connect to EPC | | |
| | | | | or to 5GC for this | | |
| | | | | PLMN. | | |
| Allowed CAGs | | 0 . . . <maxnoofCAGs> | | Allowed CAGs. | — | |
| >CAG Id | M | | INTEGER | | — | |

| Range bound | Explanation |
|---|---|
| maxnoofEPLMNs | Maximum no. of equivalent PLMNs. |
| | Value is 15. |
| maxnoofEPLMNsPlusOne | Maximum no. of allowed PLMNs. |
| | Value is 16. |
| maxnoofForbTACs | Maximum no. of forbidden Tracking |
| | Area Codes. Value is 4096. |
| maxnoofAllowedAreas | Maximum no. of allowed or not |
| | allowed Tracking Areas. Value is 16. |
| maxnoofCAGs | Maximum no. of allowed CAGs. |
| | Value is 16. |

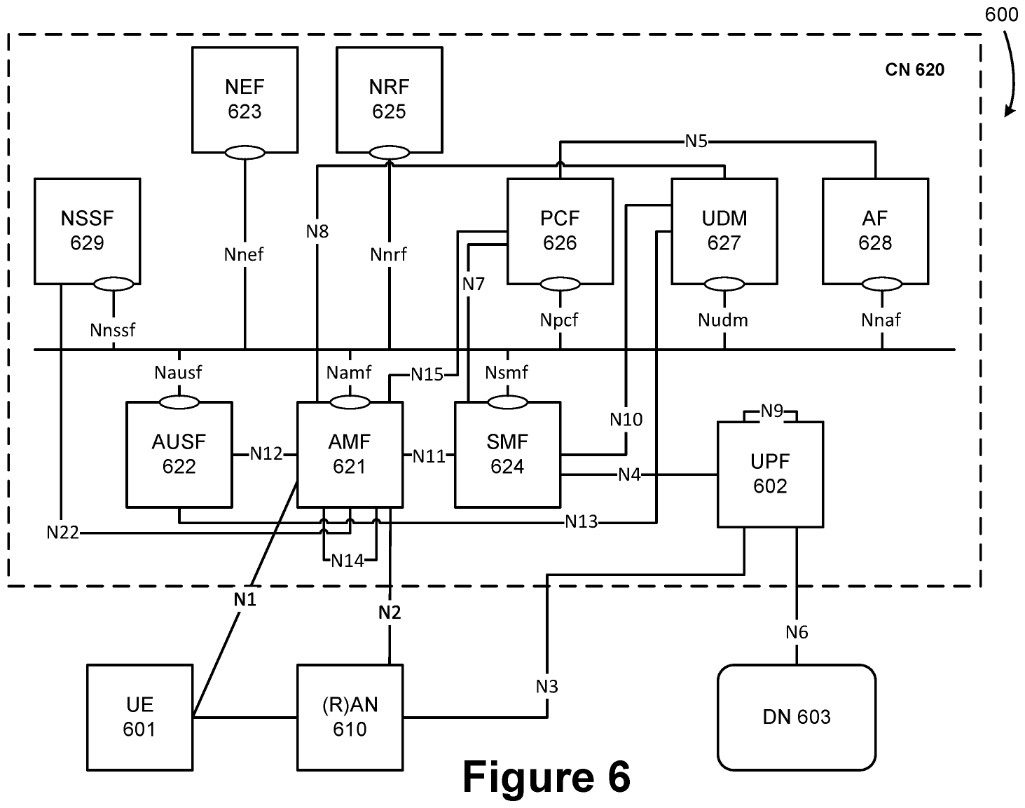

The example architectures of policy and charging control framework for the 5GS comprises a Policy Control Function (PCF), a Session Management Function (SMF), a User Plane Function (UPF), an Access and Mobility Management Function (AMF), a Network Exposure Functionality (NEF), a Network Data Analytics Function (NWDAF), an Online Charging System (OCS), an Application Function (AF), and a Unified Data Repository (UDR). Some or all of these elements are discussed in detail with regard to FIG. 6 infra. For each of the NFs, such as for PCF, the interfaces to the AF, to the OCS and NEF are similar to the PCRF interfaces to the AF, to the OCS and to the SCEF. Therefore, the PCF description refers to the PCRF for the functionality supported in 5G and the same approach applies for the AF and the NEF.

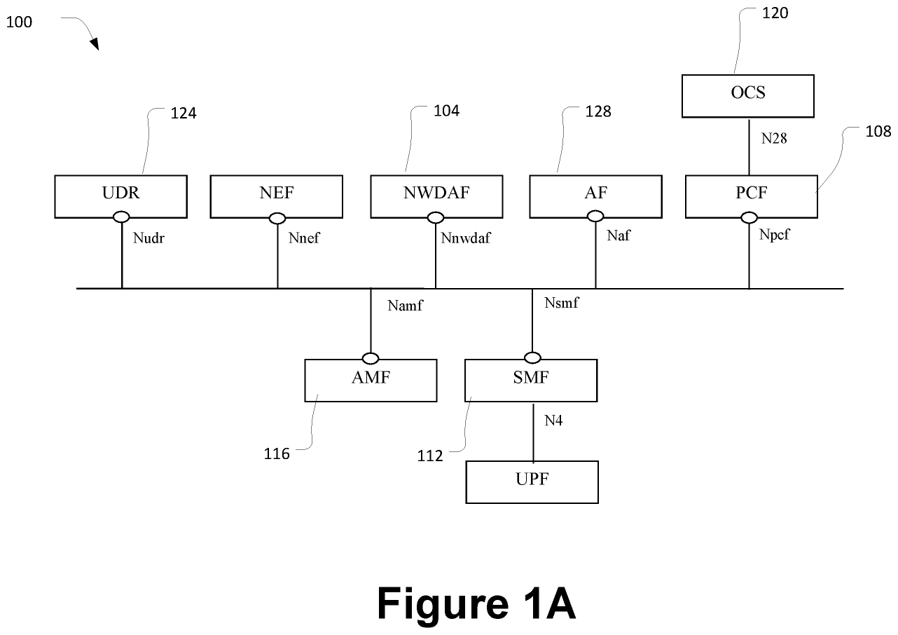

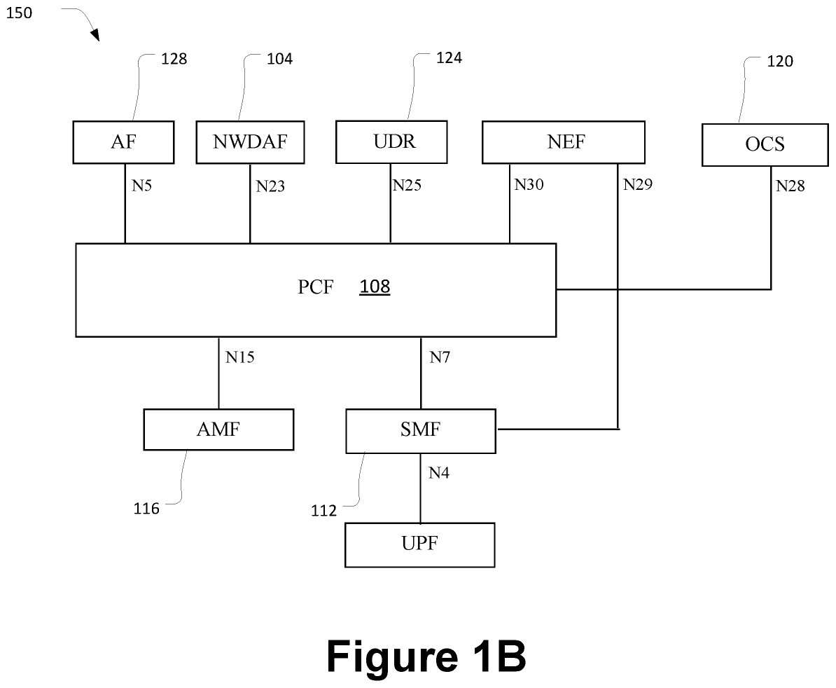

FIG. 1A illustrates a service-based representation 100 of a policy and charging control framework for a 5GS. Additionally, FIG. 1B illustrates a reference point representation 150 of the policy and charging control framework for the 5GS. Note that the N4 reference point is not part of the 5G policy framework architecture but is shown in FIGS. 1A-1B for completeness. Additionally, the PCF/NEF may store/retrieve information related to policy subscription data and/or application data, the details of which will not be further defined herein.

Referring to FIG. 1A, the Nnwdaf is a service-based interface, which are used for the NWDAF 104 to provide network data analytics (e.g., load level information) to various other entities. These services may provide NWDAF slice congestion events notifications via the Nnwdaf_EventsSubscription service and NWDAF operator specific analytics via the Nnwdaf_AnalyticsInfo service. The Nnwdaf interface may enable the PCF 108 to subscribe to and be notified about network status analytics. The NWDAF 104 may notify the PCF 108 with an identifier of a network slice instance, and load level information of the network slice instance. This information may be accepted by the PCF 108 as an input for PCC decision making along with other information from the SMF 112, AMF 116, the OCS 120, the UDF 124, and/or the AF 128. Referring to FIG. 1B, the N23 reference point is defined for the interactions between NWDAF 104 and PCF 108 in the reference point representation. The PCF 108 may access the Nnwdaf_EventsSubscription service at the NWDAF 104 via the N23 reference point.

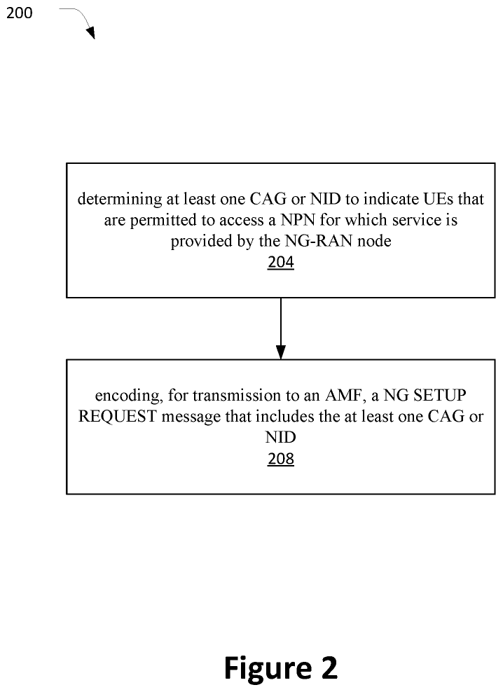

FIG. 2 illustrates an operation flow/algorithmic structure 200 in accordance with some embodiments. The operation flow/algorithmic structure 200 may be performed, in part or in whole, by a NG-RAN node (e.g., RAN nodes 411a-b, discussed infra), or components thereof. For example, in some embodiments the operation flow/algorithmic structure 200 may be performed by the baseband circuitry implemented in the NG-RAN node.

At 204, the operation flow/algorithmic structure 200 may include determining at least one CAG or NID to indicate UEs that are permitted to access a NPN for which service is provided by the NG-RAN node.

At 208, the operation flow/algorithmic structure 200 may further include encoding, for transmission to an AMF, a NG SETUP REQUEST message that includes the at least one CAG or NID.

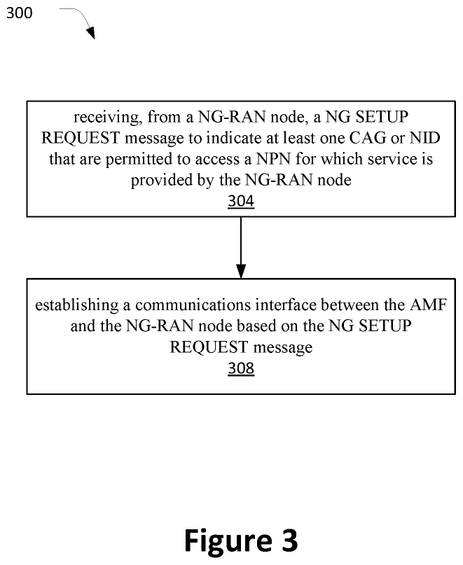

FIG. 3 illustrates another operation flow/algorithmic structure 300 in accordance with some embodiments. The operation flow/algorithmic structure 300 may be performed, in part or in whole, by an AMF (e.g., AMF 116, discussed above, and/or AMF 621, discussed infra), or components thereof. For example, in some embodiments the operation flow/algorithmic structure 300 may be performed by the baseband circuitry implemented in the AMF.

At 304, the operation flow/algorithmic structure 300 may include receiving, from a NG-RAN node, a NG SETUP REQUEST message to indicate at least one CAG or NID that are permitted to access a NPN for which service is provided by the NG-RAN node.

At 308, the operation flow/algorithmic structure 300 may further include establishing a communications interface between the AMF and the NG-RAN node based on the NG SETUP REQUEST message.

### Systems and Implementations

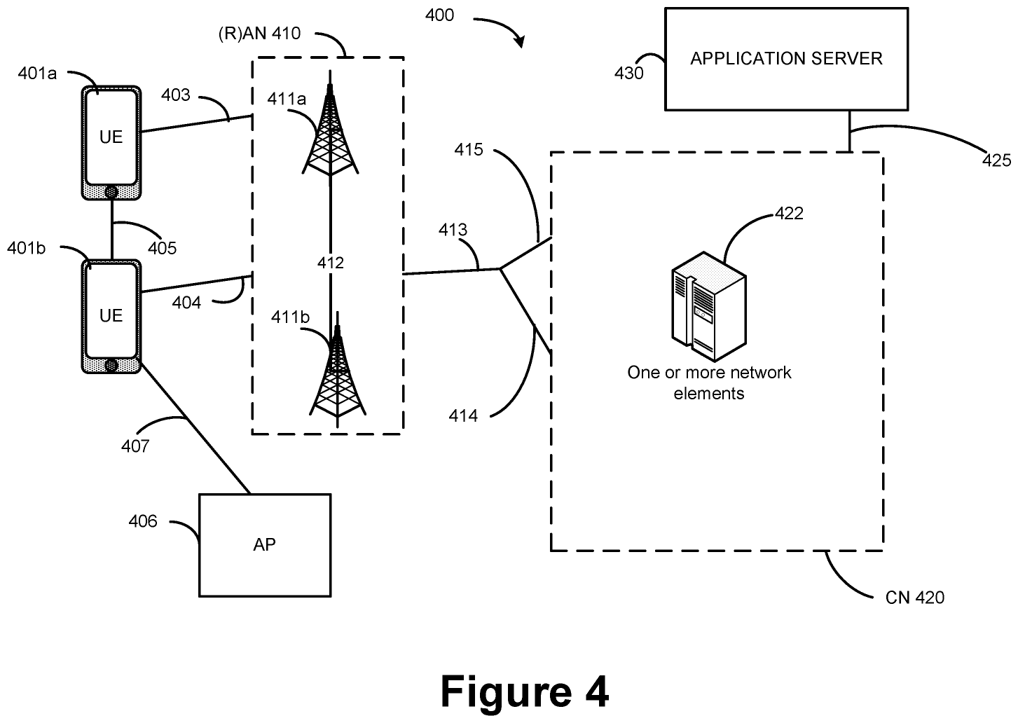

FIG. 4 illustrates an example architecture of a system 400 of a network, in accordance with various embodiments. The following description is provided for an example system 400 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 4, the system 400 includes UE 401a and UE 401b (collectively referred to as “UEs 401” or “UE 401”). In this example, UEs 401 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 401 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 401 may be configured to connect, for example, communicatively couple, with an or RAN 410. In embodiments, the RAN 410 may be an NG RAN or a 5G RAN, an E-UTRAN, or a legacy RAN, such as a UTRAN or GERAN. As used herein, the term “NG RAN” or the like may refer to a RAN 410 that operates in an NR or 5G system 400, and the term “E-UTRAN” or the like may refer to a RAN 410 that operates in an LTE or 4G system 400. The UEs 401 utilize connections (or channels) 403 and 404, respectively, each of which comprises a physical communications interface or layer (discussed in further detail below).

In this example, the connections 403 and 404 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 401 may directly exchange communication data via a ProSe interface 405. The ProSe interface 405 may alternatively be referred to as a SL interface 405 and may comprise one or more logical channels, including but not limited to a PSCCH, a PSSCH, a PSDCH, and a PSBCH.

The UE 401b is shown to be configured to access an AP 406 (also referred to as “WLAN node 406,” “WLAN 406,” “WLAN Termination 406,” “WT 406” or the like) via connection 407. The connection 407 can comprise a local wireless connection, such as a connection consistent with any IEEE 802.11 protocol, wherein the AP 406 would comprise a wireless fidelity (Wi-Fi®) router. In this example, the AP 406 is shown to be connected to the Internet without connecting to the core network of the wireless system (described in further detail below). In various embodiments, the UE 401b, RAN 410, and AP 406 may be configured to utilize LWA operation and/or LWIP operation. The LWA operation may involve the UE 401b in RRC_CONNECTED being configured by a RAN node 411a-b to utilize radio resources of LTE and WLAN. LWIP operation may involve the UE 401b using WLAN radio resources (e.g., connection 407) via IPsec protocol tunneling to authenticate and encrypt packets (e.g., IP packets) sent over the connection 407. IPsec tunneling may include encapsulating the entirety of original IP packets and adding a new packet header, thereby protecting the original header of the IP packets.

The RAN 410 can include one or more AN nodes or RAN nodes 411a and 411b (collectively referred to as “RAN nodes 411” or “RAN node 411”) that enable the connections 403 and 404. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 411 that operates in an NR or 5G system 400 (for example, a gNB), and the term “E-UTRAN node” or the like may refer to a RAN node 411 that operates in an LTE or 4G system 400 (e.g., an eNB). According to various embodiments, the RAN nodes 411 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

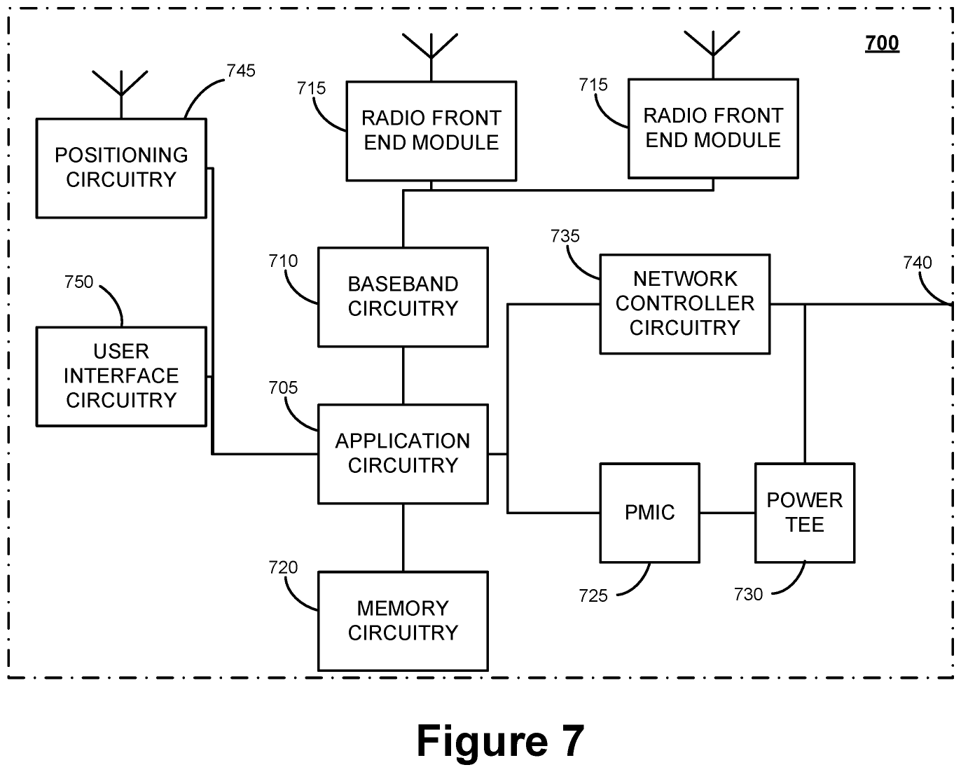

In some embodiments, all or parts of the RAN nodes 411 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 411; a MAC/PHY split wherein RRC, PDCP, RLC, and MAC layers are operated by the CRAN/vBBUP and the PHY layer is operated by individual RAN nodes 411; or a “lower PHY” split wherein RRC, PDCP, RLC, MAC layers and upper portions of the PHY layer are operated by the CRAN/vBBUP and lower portions of the PHY layer are operated by individual RAN nodes 411. This virtualized framework allows the freed-up processor cores of the RAN nodes 411 to perform other virtualized applications. In some implementations, an individual RAN node 411 may represent individual gNB-DUs that are connected to a gNB-CU via individual F1 interfaces (not shown by FIG. 4). In these implementations, the gNB-DUs may include one or more remote radio heads or RFEMs (see, e.g., FIG. 7), and the gNB-CU may be operated by a server that is located in the RAN 410 (not shown) or by a server pool in a similar manner as the CRAN/vBBUP. Additionally or alternatively, one or more of the RAN nodes 411 may be next generation eNBs (ng-eNBs), which are RAN nodes that provide E-UTRA user plane and control plane protocol terminations toward the UEs 401, and are connected to a 5GC (e.g., CN 620 of FIG. 6) via an NG interface (discussed infra).

In V2X scenarios one or more of the RAN nodes 411 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 401 (vUEs 401). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 411 can terminate the air interface protocol and can be the first point of contact for the UEs 401. In some embodiments, any of the RAN nodes 411 can fulfill various logical functions for the RAN 410 including, but not limited to, radio network controller (RNC) functions such as radio bearer management, uplink and downlink dynamic radio resource management and data packet scheduling, and mobility management.

In embodiments, the UEs 401 can be configured to communicate using OFDM communication signals with each other or with any of the RAN nodes 411 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 411 to the UEs 401, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 401 and the RAN nodes 411 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 401 and the RAN nodes 411 may operate using LAA, eLAA, and/or feLAA mechanisms. In these implementations, the UEs 401 and the RAN nodes 411 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 401 RAN nodes 411, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 401, AP 406, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 401 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 401. The PDCCH carries information about the transport format and resource allocations related to the PDSCH channel, among other things. It may also inform the UEs 401 about the transport format, resource allocation, and HARQ information related to the uplink shared channel Typically, downlink scheduling (assigning control and shared channel resource blocks to the UE 401b within a cell) may be performed at any of the RAN nodes 411 based on channel quality information fed back from any of the UEs 401. The downlink resource assignment information may be sent on the PDCCH used for (e.g., assigned to) each of the UEs 401.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

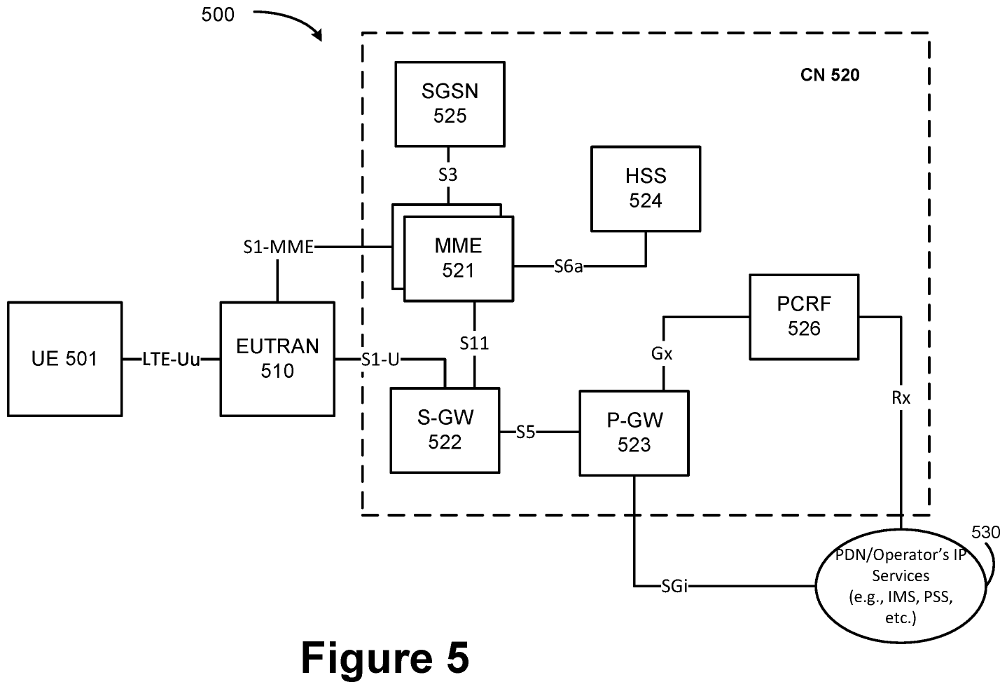

The RAN nodes 411 may be configured to communicate with one another via interface 412. In embodiments where the system 400 is an LTE system (e.g., when CN 420 is an EPC 520 as in FIG. 5), the interface 412 may be an X2 interface 412. The X2 interface may be defined between two or more RAN nodes 411 (e.g., two or more eNBs and the like) that connect to EPC 420, and/or between two eNBs connecting to EPC 420. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 401 from an SeNB for user data; information of PDCP PDUs that were not delivered to a UE 401; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 400 is a 5G or NR system (e.g., when CN 420 is an 5GC 620 as in FIG. 6), the interface 412 may be an Xn interface 412. The Xn interface is defined between two or more RAN nodes 411 (e.g., two or more gNBs and the like) that connect to 5GC 420, between a RAN node 411 (e.g., a gNB) connecting to 5GC 420 and an eNB, and/or between two eNBs connecting to 5GC 420. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 401 in a connected mode (e.g., CM-CONNECTED) including functionality to manage the UE mobility for connected mode between one or more RAN nodes 411. The mobility support may include context transfer from an old (source) serving RAN node 411 to new (target) serving RAN node 411; and control of user plane tunnels between old (source) serving RAN node 411 to new (target) serving RAN node 411. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 410 is shown to be communicatively coupled to a core network—in this embodiment, core network (CN) 420. The CN 420 may comprise a plurality of network elements 422, which are configured to offer various data and telecommunications services to customers/subscribers (e.g., users of UEs 401) who are connected to the CN 420 via the RAN 410. The components of the CN 420 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 420 may be referred to as a network slice, and a logical instantiation of a portion of the CN 420 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 430 may be an element offering applications that use IP bearer resources with the core network (e.g., UMTS PS domain, LTE PS data services, etc.). The application server 430 can also be configured to support one or more communication services (e.g., VoIP sessions, PTT sessions, group communication sessions, social networking services, etc.) for the UEs 401 via the EPC 420.

In embodiments, the CN 420 may be a 5GC (referred to as “5GC 420” or the like), and the RAN 410 may be connected with the CN 420 via an NG interface 413. In embodiments, the NG interface 413 may be split into two parts, an NG user plane (NG-U) interface 414, which carries traffic data between the RAN nodes 411 and a UPF, and the S1 control plane (NG-C) interface 415, which is a signaling interface between the RAN nodes 411 and AMFs. Embodiments where the CN 420 is a 5GC 420 are discussed in more detail with regard to FIG. 6.

In embodiments, the CN 420 may be a 5G CN (referred to as “5GC 420” or the like), while in other embodiments, the CN 420 may be an EPC). Where CN 420 is an EPC (referred to as “EPC 420” or the like), the RAN 410 may be connected with the CN 420 via an S1 interface 413. In embodiments, the S1 interface 413 may be split into two parts, an S1 user plane (S1-U) interface 414, which carries traffic data between the RAN nodes 411 and the S-GW, and the S1-MME interface 415, which is a signaling interface between the RAN nodes 411 and MMEs.

FIG. 5 illustrates an example architecture of a system 500 including a first CN 520, in accordance with various embodiments. In this example, system 500 may implement the LTE standard wherein the CN 520 is an EPC 520 that corresponds with CN 420 of FIG. 4. Additionally, the UE 501 may be the same or similar as the UEs 401 of FIG. 4, and the E-UTRAN 510 may be a RAN that is the same or similar to the RAN 410 of FIG. 4, and which may include RAN nodes 411 discussed previously. The CN 520 may comprise MMEs 521, an S-GW 522, a P-GW 523, a HSS 524, and a SGSN 525.

The MMEs 521 may be similar in function to the control plane of legacy SGSN, and may implement MM functions to keep track of the current location of a UE 501. The MMEs 521 may perform various MM procedures to manage mobility aspects in access such as gateway selection and tracking area list management. MM (also referred to as “EPS MM” or “EMM” in E-UTRAN systems) may refer to all applicable procedures, methods, data storage, etc. that are used to maintain knowledge about a present location of the UE 501, provide user identity confidentiality, and/or perform other like services to users/subscribers. Each UE 501 and the MME 521 may include an MM or EMM sublayer, and an MM context may be established in the UE 501 and the MME 521 when an attach procedure is successfully completed. The MM context may be a data structure or database object that stores MM-related information of the UE 501. The MMEs 521 may be coupled with the HSS 524 via an S6a reference point, coupled with the SGSN 525 via an S3 reference point, and coupled with the S-GW 522 via an S11 reference point.

The SGSN 525 may be a node that serves the UE 501 by tracking the location of an individual UE 501 and performing security functions. In addition, the SGSN 525 may perform Inter-EPC node signaling for mobility between 2G/3G and E-UTRAN 3GPP access networks; PDN and S-GW selection as specified by the MMEs 521; handling of UE 501 time zone functions as specified by the MMEs 521; and MME selection for handovers to E-UTRAN 3GPP access network. The S3 reference point between the MMEs 521 and the SGSN 525 may enable user and bearer information exchange for inter-3GPP access network mobility in idle and/or active states.

The HSS 524 may comprise a database for network users, including subscription-related information to support the network entities' handling of communication sessions. The EPC 520 may comprise one or several HSSs 524, depending on the number of mobile subscribers, on the capacity of the equipment, on the organization of the network, etc. For example, the HSS 524 can provide support for routing/roaming, authentication, authorization, naming/addressing resolution, location dependencies, etc. An S6a reference point between the HSS 524 and the MMEs 521 may enable transfer of subscription and authentication data for authenticating/authorizing user access to the EPC 520 between HSS 524 and the MMEs 521.

The S-GW 522 may terminate the S1 interface 413 (“S1-U” in FIG. 5) toward the RAN 510, and routes data packets between the RAN 510 and the EPC 520. In addition, the S-GW 522 may be a local mobility anchor point for inter-RAN node handovers and also may provide an anchor for inter-3GPP mobility. Other responsibilities may include lawful intercept, charging, and some policy enforcement. The S11 reference point between the S-GW 522 and the MMEs 521 may provide a control plane between the MMEs 521 and the S-GW 522. The S-GW 522 may be coupled with the P-GW 523 via an S5 reference point.

The P-GW 523 may terminate an SGi interface toward a PDN 530. The P-GW 523 may route data packets between the EPC 520 and external networks such as a network including the application server 430 (alternatively referred to as an “AF”) via an IP interface 425 (see e.g., FIG. 4). In embodiments, the P-GW 523 may be communicatively coupled to an application server (application server 430 of FIG. 4 or PDN 530 in FIG. 5) via an IP communications interface 425 (see, e.g., FIG. 4). The S5 reference point between the P-GW 523 and the S-GW 522 may provide user plane tunneling and tunnel management between the P-GW 523 and the S-GW 522. The S5 reference point may also be used for S-GW 522 relocation due to UE 501 mobility and if the S-GW 522 needs to connect to a non-collocated P-GW 523 for the required PDN connectivity. The P-GW 523 may further include a node for policy enforcement and charging data collection (e.g., PCEF (not shown)). Additionally, the SGi reference point between the P-GW 523 and the packet data network (PDN) 530 may be an operator external public, a private PDN, or an intra operator packet data network, for example, for provision of IMS services. The P-GW 523 may be coupled with a PCRF 526 via a Gx reference point.

PCRF 526 is the policy and charging control element of the EPC 520. In a non-roaming scenario, there may be a single PCRF 526 in the Home Public Land Mobile Network (HPLMN) associated with a UE 501's Internet Protocol Connectivity Access Network (IP-CAN) session. In a roaming scenario with local breakout of traffic, there may be two PCRFs associated with a UE 501's IP-CAN session, a Home PCRF (H-PCRF) within an HPLMN and a Visited PCRF (V-PCRF) within a Visited Public Land Mobile Network (VPLMN). The PCRF 526 may be communicatively coupled to the application server 530 via the P-GW 523. The application server 530 may signal the PCRF 526 to indicate a new service flow and select the appropriate QoS and charging parameters. The PCRF 526 may provision this rule into a PCEF (not shown) with the appropriate TFT and QCI, which commences the QoS and charging as specified by the application server 530. The Gx reference point between the PCRF 526 and the P-GW 523 may allow for the transfer of QoS policy and charging rules from the PCRF 526 to PCEF in the P-GW 523. An Rx reference point may reside between the PDN 530 (or “AF 530”) and the PCRF 526.

FIG. 6 illustrates an architecture of a system 600 including a second CN 620 in accordance with various embodiments. The system 600 is shown to include a UE 601, which may be the same or similar to the UEs 401 and UE 501 discussed previously; a (R)AN 610, which may be the same or similar to the RAN 410 and RAN 510 discussed previously, and which may include RAN nodes 411 discussed previously; and a DN 603, which may be, for example, operator services, Internet access or 3rd party services; and a 5GC 620. The 5GC 620 may include an AUSF 622; an AMF 621; a SMF 624; a NEF 623; a PCF 626; a NRF 625; a UDM 627; an AF 628; a UPF 602; and a NSSF 629.

The UPF 602 may act as an anchor point for intra-RAT and inter-RAT mobility, an external PDU session point of interconnect to DN 603, and a branching point to support multi-homed PDU session. The UPF 602 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 602 may include an uplink classifier to support routing traffic flows to a data network. The DN 603 may represent various network operator services, Internet access, or third party services. DN 603 may include, or be similar to, application server 430 discussed previously. The UPF 602 may interact with the SMF 624 via an N4 reference point between the SMF 624 and the UPF 602.

The AUSF 622 may store data for authentication of UE 601 and handle authentication-related functionality. The AUSF 622 may facilitate a common authentication framework for various access types. The AUSF 622 may communicate with the AMF 621 via an N12 reference point between the AMF 621 and the AUSF 622; and may communicate with the UDM 627 via an N13 reference point between the UDM 627 and the AUSF 622. Additionally, the AUSF 622 may exhibit an Nausf service-based interface.

The AMF 621 may be responsible for registration management (e.g., for registering UE 601, etc.), connection management, reachability management, mobility management, and lawful interception of AMF-related events, and access authentication and authorization. The AMF 621 may be a termination point for the an N11 reference point between the AMF 621 and the SMF 624. The AMF 621 may provide transport for SM messages between the UE 601 and the SMF 624, and act as a transparent proxy for routing SM messages. AMF 621 may also provide transport for SMS messages between UE 601 and an SMSF (not shown by FIG. 6). AMF 621 may act as SEAF, which may include interaction with the AUSF 622 and the UE 601, receipt of an intermediate key that was established as a result of the UE 601 authentication process. Where USIM based authentication is used, the AMF 621 may retrieve the security material from the AUSF 622. AMF 621 may also include a SCM function, which receives a key from the SEA that it uses to derive access-network specific keys. Furthermore, AMF 621 may be a termination point of a RAN CP interface, which may include or be an N2 reference point between the (R)AN 610 and the AMF 621; and the AMF 621 may be a termination point of NAS (N1) signalling, and perform NAS ciphering and integrity protection.

AMF 621 may also support NAS signalling with a UE 601 over an N3 IWF interface. The N3IWF may be used to provide access to untrusted entities. N3IWF may be a termination point for the N2 interface between the (R)AN 610 and the AMF 621 for the control plane, and may be a termination point for the N3 reference point between the (R)AN 610 and the UPF 602 for the user plane. As such, the AMF 621 may handle N2 signalling from the SMF 624 and the AMF 621 for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated with such marking received over N2. N3IWF may also relay uplink and downlink control-plane NAS signalling between the UE 601 and AMF 621 via an N1 reference point between the UE 601 and the AMF 621, and relay uplink and downlink user-plane packets between the UE 601 and UPF 602. The N3IWF also provides mechanisms for IPsec tunnel establishment with the UE 601. The AMF 621 may exhibit an Namf service-based interface, and may be a termination point for an N14 reference point between two AMFs 621 and an N17 reference point between the AMF 621 and a 5G-EIR (not shown by FIG. 6).

The UE 601 may need to register with the AMF 621 in order to receive network services. RM is used to register or deregister the UE 601 with the network (e.g., AMF 621), and establish a UE context in the network (e.g., AMF 621). The UE 601 may operate in an RM-REGISTERED state or an RM-DEREGISTERED state. In the RM-DEREGISTERED state, the UE 601 is not registered with the network, and the UE context in AMF 621 holds no valid location or routing information for the UE 601 so the UE 601 is not reachable by the AMF 621. In the RM-REGISTERED state, the UE 601 is registered with the network, and the UE context in AMF 621 may hold a valid location or routing information for the UE 601 so the UE 601 is reachable by the AMF 621. In the RM-REGISTERED state, the UE 601 may perform mobility Registration Update procedures, perform periodic Registration Update procedures triggered by expiration of the periodic update timer (e.g., to notify the network that the UE 601 is still active), and perform a Registration Update procedure to update UE capability information or to re-negotiate protocol parameters with the network, among others.

The AMF 621 may store one or more RM contexts for the UE 601, where each RM context is associated with a specific access to the network. The RM context may be a data structure, database object, etc. that indicates or stores, inter alia, a registration state per access type and the periodic update timer. The AMF 621 may also store a 5GC MM context that may be the same or similar to the (E)MM context discussed previously. In various embodiments, the AMF 621 may store a CE mode B Restriction parameter of the UE 601 in an associated MM context or RM context. The AMF 621 may also derive the value, when needed, from the UE's usage setting parameter already stored in the UE context (and/or MM/RM context).

CM may be used to establish and release a signaling connection between the UE 601 and the AMF 621 over the N1 interface. The signaling connection is used to enable NAS signaling exchange between the UE 601 and the CN 620, and comprises both the signaling connection between the UE and the AN (e.g., RRC connection or UE-N3IWF connection for non-3GPP access) and the N2 connection for the UE 601 between the AN (e.g., RAN 610) and the AMF 621. The UE 601 may operate in one of two CM states, CM-IDLE mode or CM-CONNECTED mode. When the UE 601 is operating in the CM-IDLE state/mode, the UE 601 may have no NAS signaling connection established with the AMF 621 over the N1 interface, and there may be (R)AN 610 signaling connection (e.g., N2 and/or N3 connections) for the UE 601. When the UE 601 is operating in the CM-CONNECTED state/mode, the UE 601 may have an established NAS signaling connection with the AMF 621 over the N1 interface, and there may be a (R)AN 610 signaling connection (e.g., N2 and/or N3 connections) for the UE 601. Establishment of an N2 connection between the (R)AN 610 and the AMF 621 may cause the UE 601 to transition from CM-IDLE mode to CM-CONNECTED mode, and the UE 601 may transition from the CM-CONNECTED mode to the CM-IDLE mode when N2 signaling between the (R)AN 610 and the AMF 621 is released.

The SMF 624 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 601 and a data network (DN) 603 identified by a Data Network Name (DNN). PDU sessions may be established upon UE 601 request, modified upon UE 601 and 5GC 620 request, and released upon UE 601 and 5GC 620 request using NAS SM signaling exchanged over the N1 reference point between the UE 601 and the SMF 624. Upon request from an application server, the 5GC 620 may trigger a specific application in the UE 601. In response to receipt of the trigger message, the UE 601 may pass the trigger message (or relevant parts/information of the trigger message) to one or more identified applications in the UE 601. The identified application(s) in the UE 601 may establish a PDU session to a specific DNN. The SMF 624 may check whether the UE 601 requests are compliant with user subscription information associated with the UE 601. In this regard, the SMF 624 may retrieve and/or request to receive update notifications on SMF 624 level subscription data from the UDM 627.

The SMF 624 may include the following roaming functionality: handling local enforcement to apply QoS SLAB (VPLMN); charging data collection and charging interface (VPLMN); lawful intercept (in VPLMN for SM events and interface to LI system); and support for interaction with external DN for transport of signalling for PDU session authorization/authentication by external DN. An N16 reference point between two SMFs 624 may be included in the system 600, which may be between another SMF 624 in a visited network and the SMF 624 in the home network in roaming scenarios. Additionally, the SMF 624 may exhibit the Nsmf service-based interface.

The NEF 623 may provide means for securely exposing the services and capabilities provided by 3GPP network functions for third party, internal exposure/re-exposure, Application Functions (e.g., AF 628), edge computing or fog computing systems, etc. In such embodiments, the NEF 623 may authenticate, authorize, and/or throttle the AFs. NEF 623 may also translate information exchanged with the AF 628 and information exchanged with internal network functions. For example, the NEF 623 may translate between an AF-Service-Identifier and an internal 5GC information. NEF 623 may also receive information from other network functions (NFs) based on exposed capabilities of other network functions. This information may be stored at the NEF 623 as structured data, or at a data storage NF using standardized interfaces. The stored information can then be re-exposed by the NEF 623 to other NFs and AFs, and/or used for other purposes such as analytics. Additionally, the NEF 623 may exhibit an Nnef service-based interface.

The NRF 625 may support service discovery functions, receive NF discovery requests from NF instances, and provide the information of the discovered NF instances to the NF instances. NRF 625 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 625 may exhibit the Nnrf service-based interface.

The PCF 626 may provide policy rules to control plane function(s) to enforce them, and may also support unified policy framework to govern network behaviour. The PCF 626 may also implement an FE to access subscription information relevant for policy decisions in a UDR of the UDM 627. The PCF 626 may communicate with the AMF 621 via an N15 reference point between the PCF 626 and the AMF 621, which may include a PCF 626 in a visited network and the AMF 621 in case of roaming scenarios. The PCF 626 may communicate with the AF 628 via an N5 reference point between the PCF 626 and the AF 628; and with the SMF 624 via an N7 reference point between the PCF 626 and the SMF 624. The system 600 and/or CN 620 may also include an N24 reference point between the PCF 626 (in the home network) and a PCF 626 in a visited network. Additionally, the PCF 626 may exhibit an Npcf service-based interface.

The UDM 627 may handle subscription-related information to support the network entities' handling of communication sessions, and may store subscription data of UE 601. For example, subscription data may be communicated between the UDM 627 and the AMF 621 via an N8 reference point between the UDM 627 and the AMF. The UDM 627 may include two parts, an application FE and a UDR (the FE and UDR are not shown by FIG. 6). The UDR may store subscription data and policy data for the UDM 627 and the PCF 626, and/or structured data for exposure and application data (including PFDs for application detection, application request information for multiple UEs 601) for the NEF 623. The Nudr service-based interface may be exhibited by the UDR 221 to allow the UDM 627, PCF 626, and NEF 623 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 624 via an N10 reference point between the UDM 627 and the SMF 624. UDM 627 may also support SMS management, wherein an SMS-FE implements the similar application logic as discussed previously. Additionally, the UDM 627 may exhibit the Nudm service-based interface.

The AF 628 may provide application influence on traffic routing, provide access to the NCE, and interact with the policy framework for policy control. The NCE may be a mechanism that allows the 5GC 620 and AF 628 to provide information to each other via NEF 623, which may be used for edge computing implementations. In such implementations, the network operator and third party services may be hosted close to the UE 601 access point of attachment to achieve an efficient service delivery through the reduced end-to-end latency and load on the transport network. For edge computing implementations, the 5GC may select a UPF 602 close to the UE 601 and execute traffic steering from the UPF 602 to DN 603 via the N6 interface. This may be based on the UE subscription data, UE location, and information provided by the AF 628. In this way, the AF 628 may influence UPF (re)selection and traffic routing. Based on operator deployment, when AF 628 is considered to be a trusted entity, the network operator may permit AF 628 to interact directly with relevant NFs. Additionally, the AF 628 may exhibit an Naf service-based interface.

The NSSF 629 may select a set of network slice instances serving the UE 601. The NSSF 629 may also determine allowed NSSAI and the mapping to the subscribed S-NSSAIs, if needed. The NSSF 629 may also determine the AMF set to be used to serve the UE 601, or a list of candidate AMF(s) 621 based on a suitable configuration and possibly by querying the NRF 625. The selection of a set of network slice instances for the UE 601 may be triggered by the AMF 621 with which the UE 601 is registered by interacting with the NSSF 629, which may lead to a change of AMF 621. The NSSF 629 may interact with the AMF 621 via an N22 reference point between AMF 621 and NSSF 629; and may communicate with another NSSF 629 in a visited network via an N31 reference point (not shown by FIG. 6). Additionally, the NSSF 629 may exhibit an Nnssf service-based interface.

As discussed previously, the CN 620 may include an SMSF, which may be responsible for SMS subscription checking and verification, and relaying SM messages to/from the UE 601 to/from other entities, such as an SMS-GMSC/IWMSC/SMS-router. The SMS may also interact with AMF 621 and UDM 627 for a notification procedure that the UE 601 is available for SMS transfer (e.g., set a UE not reachable flag, and notifying UDM 627 when UE 601 is available for SMS).

The CN 120 may also include other elements that are not shown by FIG. 6, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 6). Individual NFs may share a UDSF for storing their respective unstructured data or individual NFs may each have their own UDSF located at or near the individual NFs. Additionally, the UDSF may exhibit an Nudsf service-based interface (not shown by FIG. 6). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 6 for clarity. In one example, the CN 620 may include an Nx interface, which is an inter-CN interface between the MME (e.g., MME 521) and the AMF 621 in order to enable interworking between CN 620 and CN 520. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

FIG. 7 illustrates an example of infrastructure equipment 700 in accordance with various embodiments. The infrastructure equipment 700 (or “system 700”) may be implemented as a base station, radio head, RAN node such as the RAN nodes 411 and/or AP 406 shown and described previously, application server(s) 430, and/or any other element/device discussed herein. In other examples, the system 700 could be implemented in or by a UE.

The system 700 includes application circuitry 705, baseband circuitry 710, one or more radio front end modules (RFEMs) 715, memory circuitry 720, power management integrated circuitry (PMIC) 725, power tee circuitry 730, network controller circuitry 735, network interface connector 740, satellite positioning circuitry 745, and user interface 750. In some embodiments, the device 700 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 705 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 705 may be coupled with or may include memory/storage elements and may be configured to execute instructions stored in the memory/storage to enable various applications or operating systems to run on the system 700. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 705 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 705 may comprise, or may be, a special-purpose processor/controller to operate according to the various embodiments herein. As examples, the processor(s) of application circuitry 705 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 700 may not utilize application circuitry 705, and instead may include a special-purpose processor/controller to process IP data received from an EPC or 5GC, for example.

In some implementations, the application circuitry 705 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 705 may comprise logic blocks or logic fabric, and other interconnected resources that may be programmed to perform various functions, such as the procedures, methods, functions, etc. of the various embodiments discussed herein. In such embodiments, the circuitry of application circuitry 705 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 710 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 710 are discussed infra with regard to Figure XT.

User interface circuitry 750 may include one or more user interfaces designed to enable user interaction with the system 700 or peripheral component interfaces designed to enable peripheral component interaction with the system 700. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 715 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array XT111 of Figure XT infra), and the RFEM may be connected to multiple antennas. In alternative implementations, both mmWave and sub-mmWave radio functions may be implemented in the same physical RFEM 715, which incorporates both mmWave antennas and sub-mmWave.

The memory circuitry 720 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 720 may be implemented as one or more of solder down packaged integrated circuits, socketed memory modules and plug-in memory cards.

The PMIC 725 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 730 may provide for electrical power drawn from a network cable to provide both power supply and data connectivity to the infrastructure equipment 700 using a single cable.

The network controller circuitry 735 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 700 via network interface connector 740 using a physical connection, which may be electrical (commonly referred to as a “copper interconnect”), optical, or wireless. The network controller circuitry 735 may include one or more dedicated processors and/or FPGAs to communicate using one or more of the aforementioned protocols. In some implementations, the network controller circuitry 735 may include multiple controllers to provide connectivity to other networks using the same or different protocols.

The positioning circuitry 745 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 745 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 745 may include a Micro-Technology for Positioning, Navigation, and Timing (Micro-PNT) IC that uses a master timing clock to perform position tracking/estimation without GNSS assistance. The positioning circuitry 745 may also be part of, or interact with, the baseband circuitry 710 and/or RFEMs 715 to communicate with the nodes and components of the positioning network. The positioning circuitry 745 may also provide position data and/or time data to the application circuitry 705, which may use the data to synchronize operations with various infrastructure (e.g., RAN nodes 411, etc.), or the like.

The components shown by FIG. 7 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

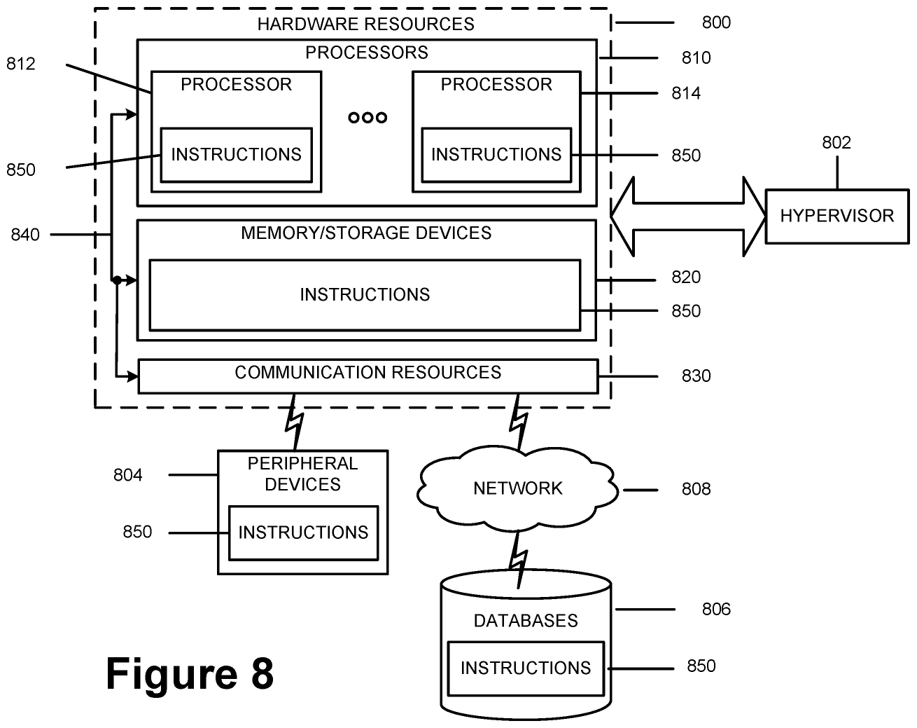

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processor(s) 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via USB), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Some non-limiting Examples of various embodiments are provided below.

Example 1 is one or more non-transitory computer-readable media (NTCRM) having instructions, stored thereon, that when executed by one or more processors cause a next generation radio access network (NG-RAN) node to: determine at least one closed access group (CAG) or network identifier (NID) to indicate user equipments (UEs) that are permitted to access a non-public network (NPN) for which service is provided by the NG-RAN node; and encode, for transmission to an access and mobility management function (AMF), a NG SETUP REQUEST message that includes the at least one CAG or NID.

Example 2 is the one or more NTCRM of Example 1, wherein the NPN is a stand-alone NPN (SNPN) and wherein the NG SETUP REQUEST message includes the at least one CAG.

Example 3 is the one or more NTCRM of Example 1, wherein the NPN is a public network integrated NPN (PNI-NPN) and wherein the NG SETUP REQUEST message includes the at least one NID.

Example 4 is the one or more NTCRM of Example 1, wherein the instructions, when executed, are further to cause the NG-RAN node to encode, for transmission to the AMF, a RAN CONFIGURATION UPDATE message to indicate an update to the at least one CAG or NID that are permitted to access the NPN.

Example 5 is the one or more NTCRM of Example 1, wherein the NG-RAN node includes a next generation base station (gNB)-centralized unit (CU), and wherein the instructions, when executed, are further to cause the gNB-CU to receive, from one or more gNB distributed units (gNB-DUs), an indication of supported CAGs or NIDs.

Example 6 is the one or more NTCRM of Example 5, wherein the instructions, when executed, are further to cause the gNB-CU to activate or deactivate one or more CAGs or NIDs based on the indication.

Example 7 is the one or more NTCRM of Example 1, wherein the instructions, when executed, are further to cause the NG-RAN node to: transmit or cause transmission of a network access request for a first UE to the AMF, wherein the network access request includes a first CAG or a first NID; and receive, from the AMF, a message to indicate whether the network access request is accepted or denied based on the first CAG or the first NID.

Example 8 is the one or more NTCRM of Example 1, wherein the instructions, when executed, are further to cause the NG-RAN node to: receive a mobility restriction list from the AMF, wherein the mobility restriction list includes an allowed CAG list; and determining a handover decision for a first UE based on the allowed CAG list.

Example 9 is the one or more NTCRM of Example 1, wherein the NG SETUP REQUEST message further includes a public land mobile network (PLMN) identifier associated with the CAG or NID.

Example 10 is one or more non-transitory computer-readable media (NTCRM) having instructions, stored thereon, that when executed by one or more processors cause an access and mobility management function (AMF) to: receive, from a next generation (NG)-radio access node (RAN) node, a NG SETUP REQUEST message to indicate at least one closed access group (CAG) or network identifier (NID) that are permitted to access a non-public network (NPN) for which service is provided by the NG-RAN node; and establish a communications interface between the AMF and the NG-RAN node based on the NG SETUP REQUEST message.

Example 11 is the one or more NTCRM of Example 10, wherein the NPN is a stand-alone NPN (SNPN) and wherein the NG SETUP REQUEST message includes the at least one CAG.

Example 12 is the one or more NTCRM of Example 10, wherein the NPN is a public network integrated NPN (PNI-NPN) and wherein the NG SETUP REQUEST message includes the at least one NID.

Example 13 is the one or more NTCRM of Example 10, wherein the instructions, when executed, are further to cause the AMF to receive, from the NG-RAN node, a RAN CONFIGURATION UPDATE message to indicate an update to the at least one CAG or NID that are permitted to access the NPN.

Example 14 is the one or more NTCRM of Example 10, wherein the instructions, when executed, are further to cause the AMF to: receive, from the NG-RAN node, a network access request for a UE, wherein the network access request includes a first CAG or a first NID; and determining whether the UE is permitted to access the NPN based on the first CAG or first NID.

Example 15 is the one or more NTCRM of Example 10, wherein the instructions, when executed, are further to cause the AMF to encode, for transmission to the NG-RAN node, a mobility restriction list that includes an allowed CAG list for handover decisions.

Example 16 is the one or more NTCRM of Example 10, wherein the NG SETUP REQUEST message further includes a public land mobile network (PLMN) identifier associated with the CAG or NID.

Example 17 is one or more non-transitory computer-readable media (NTCRM) having instructions, stored thereon, that when executed by one or more processors cause a next generation base station (gNB) centralized unit (CU) to: receive, from one or more gNB distributed units (gNB-DUs), an indication of one or more closed access groups (CAGs) or network identifiers (NIDs) that are supported by the gNB-DU for a non-public network (NPN); and activate or deactivate one or more CAGs or NIDs based on the indication.

Example 18 is the one or more NTCRM of Example 17, wherein the indication is received in a served cell information information element (IE) via an F1 interface.

Example 19 is the one or more NTCRM of Example 17, wherein the instructions, when executed, are further to cause the gNB-CU to encode an F1 setup response message, for transmission to the gNB-DU, to indicate the activated one or more CAGs or NIDs.

Example 20 is the one or more NTCRM of Example 17, wherein the NPN is a stand-alone NPN (SNPN) and wherein the indication indicates one or more CAGs.

Example 21 is the one or more NTCRM of Example 17, wherein the NPN is a public network integrated NPN (PNI-NPN) and wherein the indication indicates one or more NIDs.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. One or more non-transitory computer-readable media (NTCRM) having instructions, stored thereon, that when executed by one or more processors cause a next generation radio access network (NG-RAN) node to:
determine at least one closed access group (CAG) or network identifier (NID) to indicate user equipments (UEs) that are permitted to access a non-public network (NPN) for which service is provided by the NG-RAN node; and
encode, for transmission to an access and mobility management function (AMF), a NG SETUP REQUEST message that includes the at least one CAG or NID.

2. The one or more NTCRM of claim 1, wherein the NPN is a stand-alone NPN (SNPN) and wherein the NG SETUP REQUEST message includes the at least one CAG.

3. The one or more NTCRM of claim 1, wherein the NPN is a public network integrated NPN (PNI-NPN) and wherein the NG SETUP REQUEST message includes the at least one NID.

4. The one or more NTCRM of claim 1, wherein the instructions, when executed, are further to cause the NG-RAN node to encode, for transmission to the AMF, a RAN CONFIGURATION UPDATE message to indicate an update to the at least one CAG or NID that are permitted to access the NPN.

5. The one or more NTCRM of claim 1, wherein the NG-RAN node includes a next generation base station (gNB)-centralized unit (CU), and wherein the instructions, when executed, are further to cause the gNB-CU to receive, from one or more gNB distributed units (gNB-DUs), an indication of supported CAGs or NIDs.

6. The one or more NTCRM of claim 5, wherein the instructions, when executed, are further to cause the gNB-CU to activate or deactivate one or more CAGs or NIDs based on the indication.

7. The one or more NTCRM of claim 1, wherein the instructions, when executed, are further to cause the NG-RAN node to:
transmit or cause transmission of a network access request for a first UE to the AMF, wherein the network access request includes a first CAG or a first NID; and
receive, from the AMF, a message to indicate whether the network access request is accepted or denied based on the first CAG or the first NID.

8. The one or more NTCRM of claim 1, wherein the instructions, when executed, are further to cause the NG-RAN node to:
receive a mobility restriction list from the AMF, wherein the mobility restriction list includes an allowed CAG list; and
determining a handover decision for a first UE based on the allowed CAG list.

9. The one or more NTCRM of claim 1, wherein the NG SETUP REQUEST message further includes a public land mobile network (PLMN) identifier associated with the CAG or NID.

10. One or more non-transitory computer-readable media (NTCRM) having instructions, stored thereon, that when executed by one or more processors cause an access and mobility management function (AMF) to:
receive, from a next generation (NG)-radio access node (RAN) node, a NG SETUP REQUEST message to indicate at least one closed access group (CAG) or network identifier (NID) that are permitted to access a non-public network (NPN) for which service is provided by the NG-RAN node; and
establish a communications interface between the AMF and the NG-RAN node based on the NG SETUP REQUEST message.

11. The one or more NTCRM of claim 10, wherein the NPN is a stand-alone NPN (SNPN) and wherein the NG SETUP REQUEST message includes the at least one CAG.

12. The one or more NTCRM of claim 10, wherein the NPN is a public network integrated NPN (PNI-NPN) and wherein the NG SETUP REQUEST message includes the at least one NID.

13. The one or more NTCRM of claim 10, wherein the instructions, when executed, are further to cause the AMF to receive, from the NG-RAN node, a RAN CONFIGURATION UPDATE message to indicate an update to the at least one CAG or NID that are permitted to access the NPN.

14. The one or more NTCRM of claim 10, wherein the instructions, when executed, are further to cause the AMF to:
receive, from the NG-RAN node, a network access request for a UE, wherein the network access request includes a first CAG or a first NID; and
determining whether the UE is permitted to access the NPN based on the first CAG or first NID.

15. The one or more NTCRM of claim 10, wherein the instructions, when executed, are further to cause the AMF to encode, for transmission to the NG-RAN node, a mobility restriction list that includes an allowed CAG list for handover decisions.

16. The one or more NTCRM of claim 10, wherein the NG SETUP REQUEST message further includes a public land mobile network (PLMN) identifier associated with the CAG or NID.

17. One or more non-transitory computer-readable media (NTCRM) having instructions, stored thereon, that when executed by one or more processors cause a next generation base station (gNB) centralized unit (CU) to:
receive, from one or more gNB distributed units (gNB-DUs), an indication of one or more closed access groups (CAGs) or network identifiers (NIDs) that are supported by the gNB-DU for a non-public network (NPN); and
activate or deactivate one or more CAGs or NIDs based on the indication.

18. The one or more NTCRM of claim 17, wherein the indication is received in a served cell information information element (IE) via an F1 interface.

19. The one or more NTCRM of claim 17, wherein the instructions, when executed, are further to cause the gNB-CU to encode an F1 setup response message, for transmission to the gNB-DU, to indicate the activated one or more CAGs or NIDs.

20. The one or more NTCRM of claim 17, wherein the NPN is a stand-alone NPN (SNPN) and wherein the indication indicates one or more CAGs.

21. The one or more NTCRM of claim 17, wherein the NPN is a public network integrated NPN (PNI-NPN) and wherein the indication indicates one or more NIDs.
